(19) United States
(12) Patent Application Publication
(10) Pub. No.: US 2007/0245541 A1
(43) Pub. Date: Oct. 25, 2007

(54) Metal plate joining method and structure

(75) Inventor: Yutaka Kanaguchi, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/732,464

(22) Filed: Apr. 3, 2007

(30) Foreign Application Priority Data
Apr. 10, 2006 (JP) 2006-107563

(51) Int. Cl. B23P 13/04

(52) U.S. Cl. 29/557

(57) ABSTRACT

The metal plate joining method for using electric resistance welding in combination with an adhesive and joining at least two or more metal plates includes the steps of: continuously coating the adhesive on at least one flange out of flanges respectively formed in the plurality of the metal plates; then superimposing the one flange on the other flange; making a protrusion formed in any one flange out of the two flanges abut with the other flange; and forming a gap between the two flanges at a flange inner edge side of the protrusion, wherein while suppressing a move of the adhesive to a flange outer edge by the protrusion, the two flanges push the gap and are welded by the electric resistance welding.

### BACKGROUND OF THE INVENTION

1. Field of the Invention

The present invention relates to a metal plate joining method and structure for joining a plurality of metal plates, using electric resistance welding in combination with an adhesive.

2. Description of the Related Art

Conventionally, it is performed to use electric resistance welding in combination with an adhesive and join metal plates such as two steel plates. For example, in a field of an automobile, accompanied with a need of weight saving of a car body, a place tends to largely increase where plates are joined using electric resistance welding in combination with an adhesive.

An adhesive used in this case is a structural adhesive such as a weldbond. Broadly classifying the structural adhesive from a viewpoint of a viscosity, there exist two kinds in the adhesive: one higher and the other lower in viscosity at a room temperature.

Generally, although an adhesive higher in viscosity can be discharged by a temperature adjustment at a higher temperature, the viscosity of the adhesive becomes higher if steel plates are not joined to each other within a short time after being discharged, and thereby, the adhesive does not ideally widen; therefore, there is a problem that spot welding cannot be performed in a subsequent process.

On the other hand, generally in an adhesive lower in viscosity it is not necessary to make the adhesive a higher temperature in discharging it, and it is possible to keep the viscosity at a room temperature; therefore, there is a large merit that spot welding is easily performed in a subsequent process.

FIGS. 6A and 6B are drawings showing a state when two steel plates are joined, using conventional electric resistance welding in combination with an adhesive; FIG. 6A is a perspective view of a main part showing a state when the adhesive is coated on one of the steel plates; and FIG. 6B is an enlarged section view of the main part. FIGS. 7A to 7C are drawings showing a state when two steel plates are joined, using conventional electric resistance welding in combination with an adhesive; FIG. 7A is a perspective view; FIG. 7B is an enlarged section view in an arrow view X-X direction of FIG. 7A; and FIG. 7C is an enlarged section view in an arrow view W-W direction of FIG. 7A.

Next, referring to FIGS. 6A to 7C, will be described a case of joining two steel plates 100, 200 and forming a joint structural body 300, using an electric resistance welding in combination with an adhesive 400.

In this case, firstly as shown in FIGS. 6A and 6B, the adhesive 400 is continuously coated like a bead on a flange 110 of a lower side steel plate 100.

Next as shown in FIG. 7A, a flange 210 of an upper side steel plate 200 is placed on the flange 110 of the lower side steel plate 100. Furthermore, as shown in FIG. 7C, pushing electrodes 500 of a spot welder from up and down directions to the superimposed flanges 110, 210, spot welding (electric resistance welding) is performed.

If the spot welding is performed, a vicinity of a welded portion 310 of the steel plates 100, 200 is pushed and welded by the electrodes 500, 500 as shown in FIG. 7C, and thereby, the steel plates 100, 200 become in contact with each other and are joined by a nugget (melting-solidification portion). At this time, because an existence space of the adhesive 400 is lost due to the contact of the respective steel plates 100, 200 in the vicinity of the welded portion 310, the adhesive 400 flows outside by the electrodes 500, 500 pushing the steel plates 100, 200 and protrudes from the flanges 110, 210.

In addition, as shown in FIG. 7A, because a large pushing force by the electrodes 500, 500 is not added to an intermediate portion of welded portion 310, 310 of the steel plates 100, 200 spot-welded at a predetermined interval to the flanges 110, 210 and the nugget is not generated, the adhesive 400 is made to intervene in a state of not protruding from between the flanges 110, 210 as shown in FIG. 7B.

However, as shown in FIG. 7C, in a case of the adhesive 400 protruding from the joined steel plates 100, 200, because the adhesive 400 is apt to adhere to such clothes and gloves of a worker and further to other products and parts, there is a problem that manpower increases for wiping out the adhesive 400 protruded from the flanges 110, 210.

Moreover, there is a problem that the protruded adhesive 400 is apt to drop by gravity and to smear such equipment within a factory, and thereby, that maintenance manpower increases.

Furthermore, in a case of performing electrodeposition coating in a process after welding, there is such a problem that the protruded adhesive 400 is apt to flow out in an electrodeposition coating liquid and to contaminate the liquid.

In such a weldbond method, as something for preventing an adhesive from protruding from a steel plate is known a steel plate joining structure where a convex portion for forming a gap, where the adhesive is reserved, between a welded portion of one joined steel plate (for example, see Japanese Patent Laid-Open Publication No. 2004-82136 (claims, FIG. 1)).

However, in a steel plate joining structure like the Japanese Patent Laid-Open Publication No. 2004-82136, a place where an adhesive for joining steel plates is provided is limited within a gap formed by a convex portion disposed at a predetermined interval in a flange.

Thus in a case of coating an adhesive on a place with which an intermittently disposed convex portion matches, because the adhesive has a viscosity and drops and adheres on/to an unnecessary place in being coated; therefore, there is a problem that the adhesive cannot efficiently be coated in a short time and that a productivity is bad.

Furthermore, in the steel plate joining structure of the Japanese Patent Laid-Open Publication No. 2004-82136, because the adhesive is not coated at the joined portion of spot welding of steel plates and at a periphery of the portion and an adhesion area by the adhesive is smaller, there is a problem that a strength and rigidity of a joined place lowers.

Moreover, in the steel plate joining structure of the Japanese Patent Laid-Open Publication No. 2004-82136, the adhesive is filled in the gap formed intermittently and the steel plates are joined. As a result thereof, because a metal fatigue strength lowers with respect to an external force at the place adhered by the adhesive, there is a problem that the adhesive cannot be made to contribute to an enhancement of the fatigue strength by spot welding.

In addition, in a case of coating an adhesive on a flange continuously and joining steel plates, there is a problem as shown in FIG. 7C that because an existence space of an adhesive 400 is lost due to contact of respective steel plates 100, 200 in a vicinity of a welded portion 310, the adhesive 400 protrudes from flanges 110, 210.

In a case of the adhesive 400 protruding from the steel plates 100, 200, because the protruded adhesive 400 becomes an obstacle and other member cannot be attached thereto, there is a problem that a wiping-out work has to be performed.

Consequently, there is a need for a metal plate joining method and structure that are easy in a joining work of metal plates and enables a protrusion amount of an adhesive to be suppressed.

### SUMMARY OF THE INVENTION

A first aspect of the present invention is a metal plate joining method for using electric resistance welding in combination with an adhesive and joining at least two or more metal plates, and the method comprises the steps of: continuously coating the adhesive on at least one flange out of flanges respectively formed in the plurality of the metal plates; then superimposing the one flange on the other flange; making a protrusion formed in any one flange out of the two flanges abut with the other flange; and forming a gap between the two flanges at a flange inner edge side of the protrusion, wherein while suppressing a move of the adhesive to a flange outer edge by the protrusion, the two flanges push the gap and are welded by the electric resistance welding.

In accordance with the first aspect of the present invention, for example, in two metal plates (at least two or more metal plates) an adhesive is continuously coated on at least one flange out of flanges; then the one flange is superimposed on the other flange; a protrusion formed in any one flange out of the two flanges is made to abut with the other flange; and a gap is formed between the two flanges at a flange inner edge side of the protrusion. Because the protrusion is configured to intervene between the two flanges, an interval of the gap is kept a protruded height of the protruded adhesive.

Moreover, if the two flanges pushes the gap and are joined by electric resistance welding, a move of the adhesive to a flange outer edge is suppressed by the protrusion; therefore, the adhesive is prevented from protruding from the flanges.

A second aspect of the present invention is a metal plate joining structure for using electric resistance welding in combination with an adhesive and joining at least two or more metal plates, and the structure comprises a protrusion configured to suppress a move of the adhesive to a flange outer edge and formed in at least one flange out of flanges respectively formed in the plurality of the metal plates, wherein the adhesive is configured to intervene with a periphery of the protrusion between the flange of the metal plates, and electric resistance welding is performed for a flange inner edge side of the protrusion of the flange.

In accordance with the second aspect of the present invention, for example, in metal plates, because a protrusion configured to suppress a move of an adhesive to a flange outer edge is formed in one flange, the adhesive is prevented from protruding from the flange outer edge by welding a flange inner edge side of the protrusion in electric resistance welding.

A third aspect of the present invention is the metal plate joining structure of the second aspect, and the structure comprises a plurality of protrusions configured to be disposed so as to surround through a predetermined interval a periphery of a welded portion welded by electric resistance welding, wherein at least one of the plurality of the protrusions is disposed at the flange outer edge side of the welded portion.

In accordance with the third aspect of the present invention, the structure comprises a plurality of protrusions configured to be disposed so as to surround a periphery of a welded portion through a predetermined interval, and at least one of the plurality of the protrusions is disposed at a flange outer edge side of the welded portion. Therefore, after coating an adhesive on a flange, if performing electric resistance welding for the welded portion, the adhesive, which is pushed by electrodes of an electric resistance welder and exists in the electrode portion, is pushed by a joining face of the flange pushed by the electrodes and flows into the periphery. The flowed adhesive is prevented from flowing into the flange outer edge side by the protrusions disposed around the welded portion and flows in a direction where a protrusion is not disposed. As a result thereof, the adhesive is prevented from protruding from the flange outer edge.

### BRIEF DESCRIPTION OF THE DRAWINGS

FIGS. 1A and 1B are drawings showing a metal plate joining method and structure with respect to an embodiment of the present invention; FIG. 1A is a perspective view of a main part of joined metal plates; and FIG. 1B is an enlarged drawing of a part A in FIG. 1A.

FIGS. 2A and 2B are drawings showing the metal plate joining method and structure with respect to the embodiment; FIG. 2A is an enlarged exploded perspective view of a main part showing a state when an adhesive is coated on metal plates; and FIG. 2B is an enlarged plan view of the main part.

FIGS. 3A and 3B are drawings showing the metal plate joining method and structure with respect to the embodiment; FIG. 3A is an enlarged exploded perspective view of a main part showing a state when upper and lower metal plates are joined with the adhesive; and FIG. 3B is an enlarged plan view of the main part.

FIGS. 4A and 4B are drawings showing the metal plate joining method and structure with respect to the embodiment; FIG. 4A is an enlarged perspective view of a main part showing a state when electric resistance welding is performed; and FIG. 4B is the enlarged plan view of the main part; FIG. 4C is a section view in an arrow view Y-Y direction of FIG. 4B; and FIG. 4D is a section view in an arrow view Z-Z direction of FIG. 4B.

FIG. 5 is a graph showing a relationship between a round bead diameter of a discharged adhesive discharged from a nozzle in an adhesive coating process and a broadening width of an adhesive in welding.

FIGS. 6A and 6B are drawings showing a state when two steel plates are joined, using conventional electric resistance welding in combination with an adhesive; FIG. 6A is a perspective view of a main part showing a state when the adhesive is coated on the steel plates; and FIG. 6B is an enlarged section view of the main part.

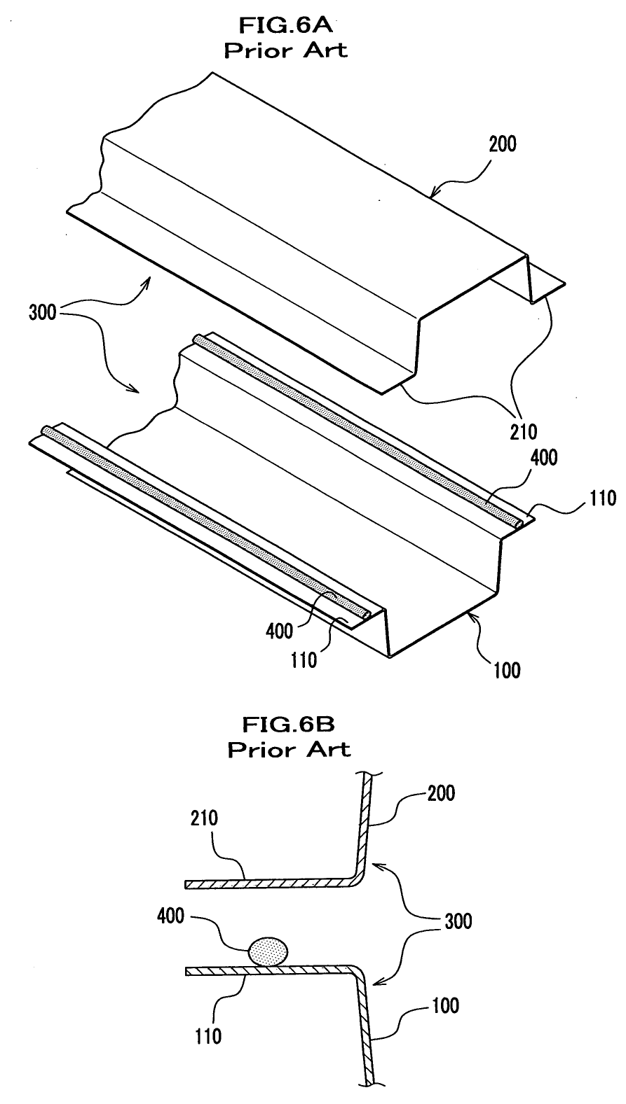

FIGS. 7A to 7C are drawings showing a state when the two steel plates are joined, using conventional electric resistance welding in combination with the adhesive; FIG. 7A is a perspective view; FIG. 7B is an enlarged section view in an arrow view X-X direction of FIG. 7A; and FIG. 7C is an enlarged section view in an arrow view W-W direction of FIG. 7A.

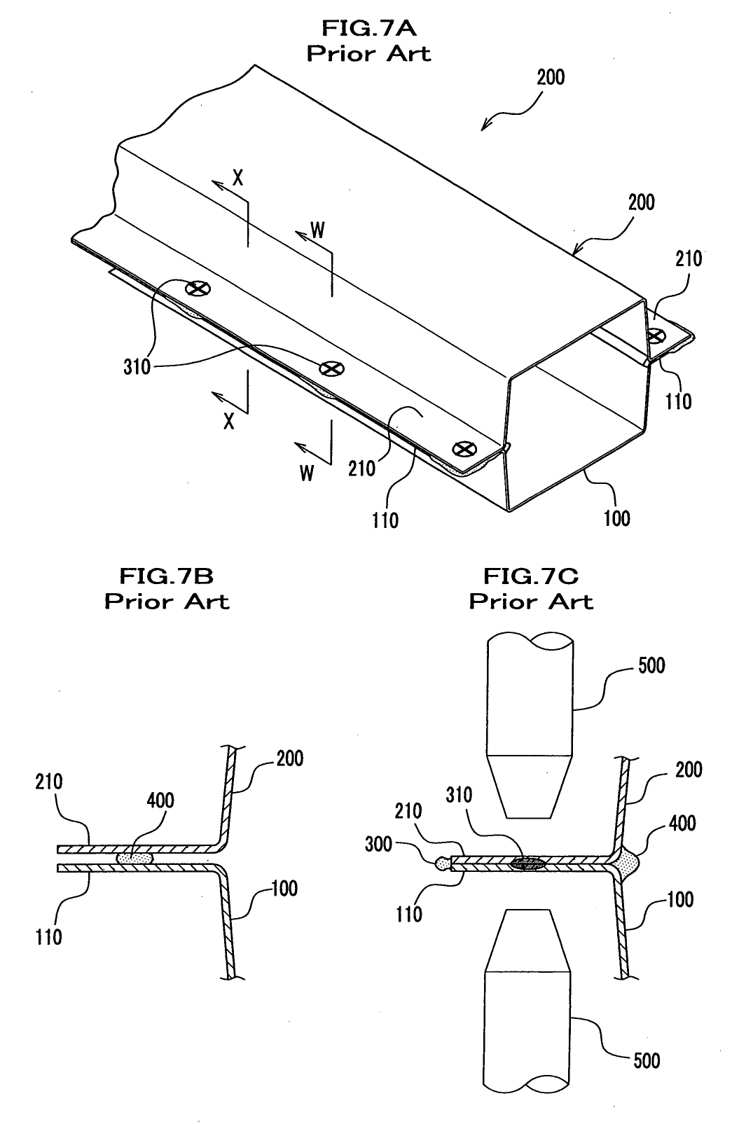

### BEST MODE(S) FOR CARRYING OUT THE INVENTION

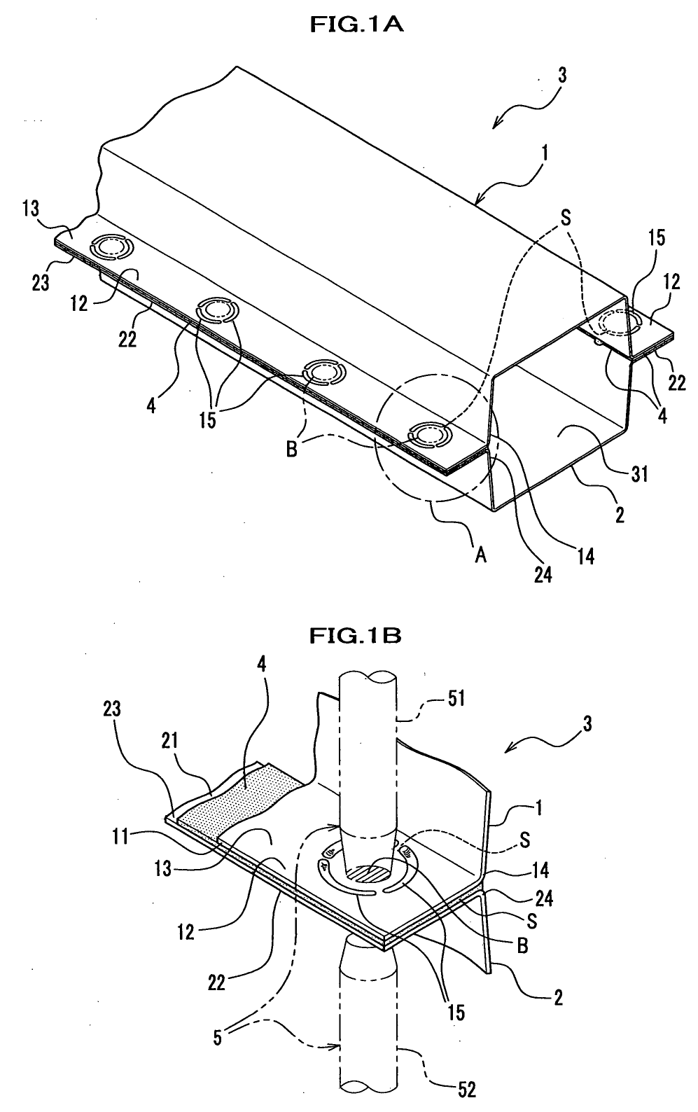

Here will be described a metal plate joining method and structure of the present invention, referring to FIGS. 1A to 5. In addition, in an embodiment of the invention an up and down direction and left and right direction change according to respective directions of metal plates and electrodes of a spot welder; therefore, a description will be made, assuming an upper side of a drawing “up” and a lower side thereof “down.”

<<Configuration of Metal Plate>>

As shown in FIG. 1A, metal plates 1, 2 are so called “weldbonded” flat plate members made of metal that are joined, using electric resistance welding in combination with an adhesive 4. The metal plates 1, 2 are formed of a weldable metal such as carbon steel, low alloy steel, stainless steel, and aluminum alloy. As shown in FIG. 1B, if the metal plates 1, 2 have joining faces 11, 21 for joining both with using electric resistance welding in combination with the adhesive 4, their shape is not specifically limited. Hereafter will be described the embodiment, citing as an example the metal plates 1, 2 having flanges 12, 22 as the joining faces 11, 21.

The metal plates 1, 2 are, for example, comprised of channel steel with collar having the flanges 12, 22 folded like an L-letter shape in an outside direction at left and right both end sides, and are formed by such press forming. The upper side metal plate 1 and the lower side metal plate 2 are matched by respectively joining the joining faces 11, 21 of the flanges 12, 22, and form a joined structural body 3 of a hollow portion 31 (see FIG. 1A) for forming a closed section.

<Configuration of Joined Structural Body>

As shown in FIG. 1A, the joined structural body 3 is comprised of, for example, a square tubular member made by matching the metal plates 1, 2 of an approximately symmetrical shape in up and down, and is used, for example, as a member for configuring a skeleton of such a side sill and center pillar of an automobile. The joined structural body 3 is adhered, making the adhesive 4 intervene between the left and right flanges 12, 22 of the metal plates 1, 2, and moreover, is made by joining the metal plates 1, 2 through welded portions B intermittently welded to the flanges 12, 22 at a predetermined interval.

As shown in FIG. 1B, each of the welded portions B is a place welded with heat due to an electric resistance by making a current flow between the metal plates 1, 2 so as to pinch the flanges 12, 22 of the metal plates 1, 2 from up and down directions by electrodes 51, 52 of a spot welder 5. In the welded portion B, on a surface are formed indentations of the electrodes 51, 52. In addition, an appropriate number of welded portions B are formed, depending on a size and thickness of the joined structural body 3, a longitudinal length of the flanges 12, 22, and the like.

<Configuration of Flange>

The flanges 12, 22 are extended along, for example, the hollow portion 31 (see FIG. 1A) of the joined structural body 3 and are approximately formed like an girdle. At least in one metal plate (for example, the upper side metal plate 1) out of the two metal plates 1, 2 are formed protrusions 15 for suppressing a move of the adhesive 4 to flange outer edges 13, 23 of the flanges 12, 22. Between the flange 12 of the upper side metal plate 1 and the flange 22 of the lower side metal plate 2, the adhesive 4 continuously coated like a bead is made to intervene in a state of being extended, and is disposed at least around the protrusions 15. In the flanges 12, 22 opposite sides of the flange outer edges 13, 23 are spot-welded (electric-resistance-welded) by the spot welder 5.

<Configuration of Protrusion>

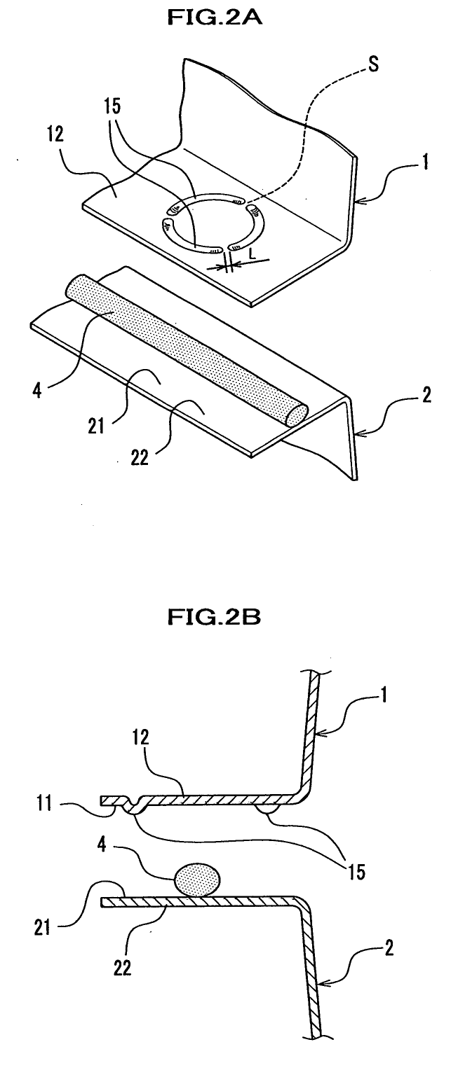

As shown in FIG. 2B, the protrusions 15 are protruded downward at a lower side of the flange 12 of the upper side metal plate 1, and when the metal plate 1 is placed on an upper face (joining face 21) of the lower side metal plate 2, the protrusions 15 are adapted to be joined with pressure on the upper face of the flange 22. The protrusions 15 are made by the metal plate 1 being press-formed into a concave shape toward the flange 22 of the lower side metal plate 2, and upper face sides of the protrusions 15 are formed into a groove shape of an approximate semi-circle in section. The protrusions 15 consist, for example, of a plurality of protrusions formed like an arc in plan view, and are annularly disposed around a welded portion B so as to surround the portion B with keeping a predetermined interval L (see FIG. 2A).

Here, the predetermined interval L is an arbitrary interval, may be not less than a width by which the adhesive 4 can flow between protrusions 15, 15, and a length of the interval L is not specifically limited.

In addition, the protrusions 15 are intermittently and annularly disposed, and thereby, when the flanges 12, 22 of the upper and lower side metal plates 1, 2 are pushed by the electrodes 51, 52 and are in contact with each other, the protrusions 15 are formed to suppress the adhesive 4 existing within the protrusions 15 annularly disposed from flowing outside the protrusions 15 therefrom and to direct the adhesive 4 to flow out in a predetermined direction from between protrusions 15, 15.

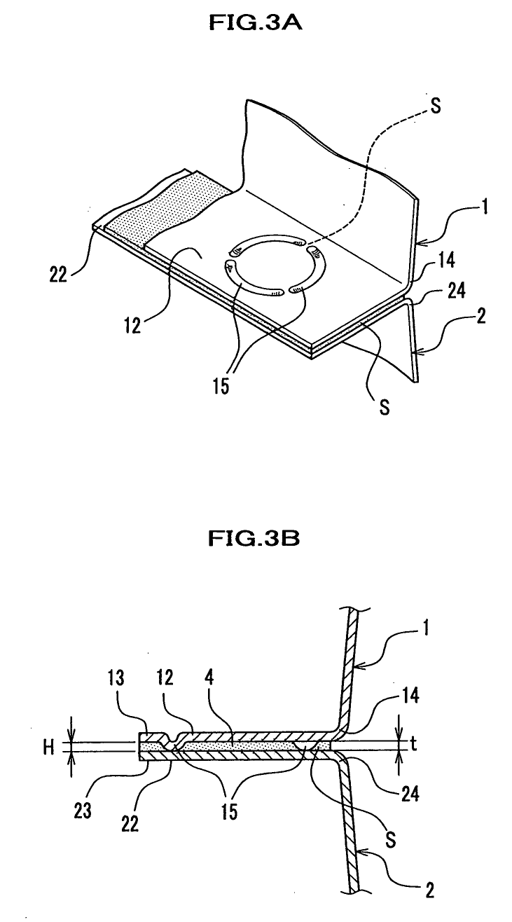

As shown in FIG. 3B, a height H (for example, 0.2 mm or so) of the protrusions 15 protruding from a lower face of the flange 12 is formed the same as a thickness t of an adhesive layer set by the adhesive 4.

<<Composition of Adhesive>>

For example, the adhesive 4 is composed of a structural adhesive such as a liquid-hardening epoxy resin adhesive and a liquid-hardening vinyl chloride resin synthetic rubber adhesive, and has a high adhesion strength and a fatigue property.

<<Action of Metal Plate Joining Method and Structure>>

Next will be described an action of a metal plate joining method and structure, referring to FIGS. 1A to 5.

<Description of Adhesive Coating Process>

In a case of joining the metal plates 1, 2 and making the joined structural body 3 will be firstly performed an adhesive coating process of coating the adhesive 4 on the metal plates 2.

In a case of performing the adhesive coating process are firstly removed such an oil constituent and dust adhered to an upper face (joining face 21) of the flange 22 of the lower side plate 2, where the adhesive 4 is coated, and a lower face (joining face 11) of the flange 12 of the upper side plate 1, where the flange 22 is joined. Then a predetermined amount of the adhesive 4 is continuously coated like a bead with a predetermined thickness from one end to the other end of an upper face center portion of the flange 22 along a longitudinal direction thereof.

<Description of Adhesive Joining Process>

Next will be performed an adhesive joining process for joining the metal plates 1, 2 with the adhesive 4.

In the adhesive joining process, as shown in FIGS. 2A, B, placing and pushing the flange 12 of the upper side metal plate 1 on the flange 22 where the adhesive 4 is coated, the flanges 12, 22 are joined to each other.

At this time, the upper side flange 12 becomes a state of the protrusions 15 being joined with pressure to the upper face of the lower side flange 22. Consequently, as shown in FIGS. 3A, 3B, while the adhesive 4 placed on the lower side flange 22 is pushed to the lower face of the upper side flange 12 and extends and flows in lateral directions, the adhesive 4 contacts the upper face of the lower side flange 22 and the lower face of the upper side flange 12.

A thickness t of the adhesive 4 at this time is, as shown in FIG. 3B, the same as the height H of the protrusions 15. Because in the flange 12 a plurality of the protrusions 15 are formed and thereby an interval between the flanges 12, 22 is kept the height H of the protrusions 15 by the protrusions 15, the thickness t of an adhesive layer of the adhesive 4 made to intervene between the flanges 12, 22 becomes uniform in all of the flanges 12, 22.

<Description of Welding Process>

Next will be performed a welding process of performing electric resistance welding for the metal plates 1, 2.

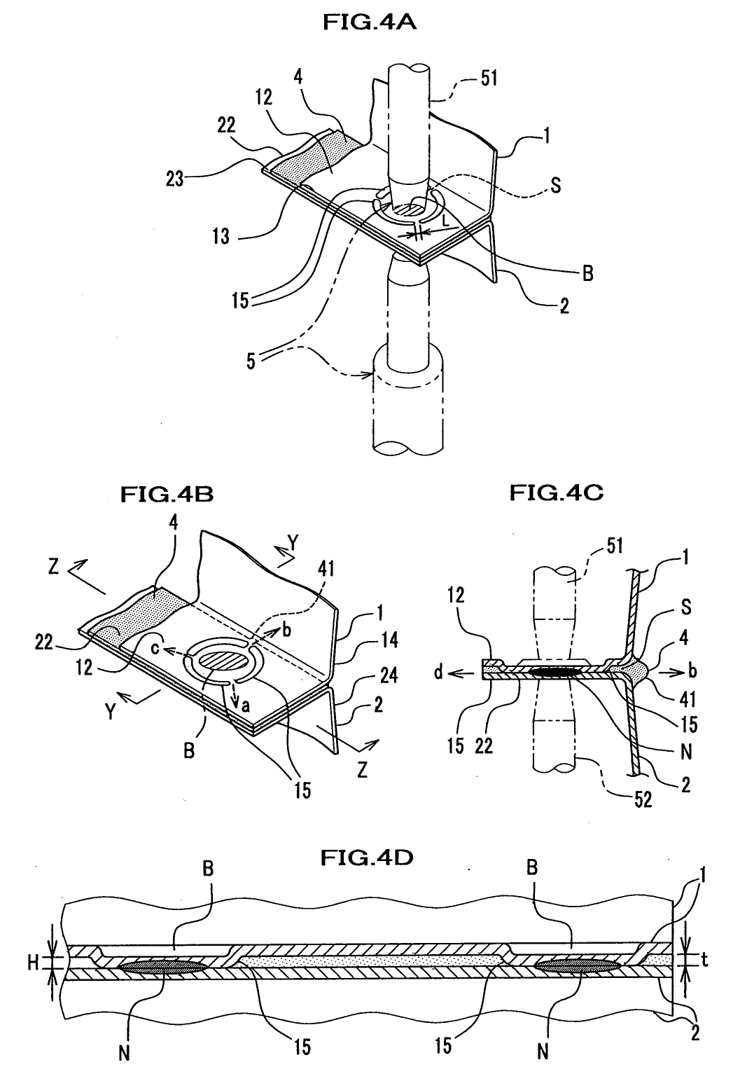

As shown in FIG. 4A, in welding and joining the flanges 12, 22, for example, the welding is performed by an electric resistance welder such as the spot welder 5.

In welding, firstly placing the lower side metal plate 22 on the lower side electrode 52 of the spot welder 5, making the upper side electrode 51 abut with a welded portion B, passing electricity through the portion B with pressurizing it, generating resistance heat in the portion B, melting the portion B by the heat, and generating a nugget N, thus the flanges 12, 22 are welded to each other. Then other welded portions B of the flanges 12, 22 are sequentially welded.

The welded portion B to be welded exists, as shown in FIG. 4A, within an annular circle formed by a plurality of the protrusions 15 like an arc in the upper side flange 12 through the predetermined interval L. Therefore, in a case of welding the welded portion B, only inside of the annular circle of the protrusions 15 of the flange 12 as shown in FIG. 4B is pushed to the electrode 51 and sinks as if squashed as shown in FIG. 4C, the welded portion B of each of the flanges 12, 22 is joined with pressure and melted, and is welded with the nugget N being formed.

At this time the adhesive 4 existing within the annular circle of the protrusions 15 shown in FIG. 3B is regulated in a flow direction by the protrusions 15 in flowing outside from within the annular circle, because tips of the protrusions 15 are joined with pressure to the upper face of the lower side flange 22.

Therefore, the adhesive 4 existing within the annular circle of the protrusions 15 flows, as shown in FIG. 4B, in arrow-mark a, b, and c directions outside the annular circle from between respective protrusions 15, 15, 15. Thus flow directions where the adhesive 4 flows are the arrow-mark a, b, and c directions between respective protrusions 15, 15, 15, and it is possible to freely set and control the flow directions.

Then the adhesive 4 flowing in welding is only the adhesive 4 existing in a sinking place, which is pushed by the electrode 51, of the upper side flange 12, and a small amount of the adhesive 4 existing within the annular circle of the protrusions 15.

Because an amount of the adhesive 4 flowing in welding is small, there is a possibility in an adhesive 41 protruding from the flanges 12, 22 as shown in FIG. 4B that only the adhesive 41 moving near flange inner edges 14, 24 in an outside direction of the arrow mark b from the annular circle of the protrusions 15 protrudes from the flanges 12, 22 as shown in FIG. 4C. However, the adhesive 41 protruded from the flanges 12, 22 is slight and a small amount; moreover, because the adhesive 41 protrudes into the hollow portion 31 of the joined structural body 3 (see FIG. 1A), there occurs no inconveniency by the adhesive 41 and a wiping-out work is unnecessary.

Thus in the welded portion B of the flanges 12, 22 the circular nugget (melting-solidification portion) N is formed and the portion B is firmly welded even if the adhesive 4 is made to intervene between the flanges 12, 22.

As shown in FIG. 4D, between respective welded portions B, B in a longitudinal direction of the flanges 12, 22, even if the inside of the annular circle of the protrusions 15 is squashed by the electrode 51 and welded, the original height H of the protrusions 15 does not change; therefore, the space of the respective welded portions B, B has become a state that: the interval of the height H of the protrusions 15 is kept the thickness t; an adhesive layer is formed between the flanges 12, 22; and the adhesive 4 is uniformly filled in the thickness t.

Thus in the present invention, because the thickness t of the set adhesive layer of the adhesive 4 is kept by spot welding the inside of the annular circle of the protrusions 15 disposed annularly, it is possible to eliminate all of the flanges 12, 22 from contacting and the thickness t of the adhesive layer from becoming 0 mm.

Furthermore, because it is only the inside of the annular circle of the protrusions 15 that the gap S between the flanges 12, 22 becomes 0 mm by the electrodes 51, 52 of the spot welder 5 due to the adhesive 4 intervening between the flanges 12, 22 in the adhesive joining process and the gap S of other places between the flanges 12, 22 becomes the height H of the protrusions 15, it is possible to extremely lessen a variation of a broadening width of the adhesive 4 and to make the width the set thickness t.

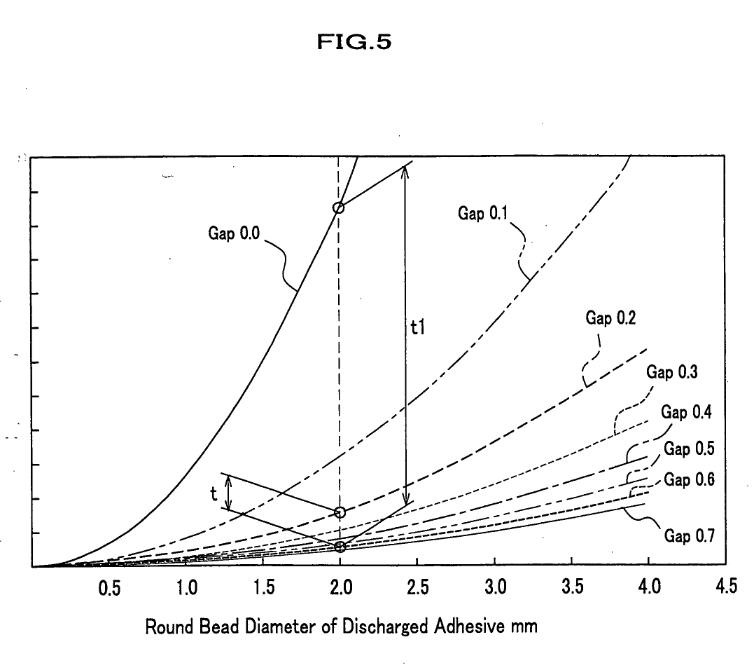

As shown in FIG. 5, in the embodiment is used round bead diameter 2.0 mm (2.0 mm or so) of the adhesive 4 discharged from a nozzle. In this case the thickness t of the adhesive 4 is, as described before, approximately constant, and even if there exists an error, it is 0.2 mm to 0.7 mm. Therefore, the broadening width of the adhesive 4 is t shown in FIG. 5 and extremely small.

In this connection, in a case of there existing no protrusion 15, the lower side flange 22 and the upper side flange 12 contact in welding, a gap shown in FIG. 5 becomes 0.0 mm, and a broadening width t1 also widely broadens, about ten folds.

Compared to this, the present invention can lessen the broadening width of the adhesive 4 and easily make the width of the adhesive 4 a set width.

In the metal plates 1, 2 thus joined, the joining work of the metal plates 1, 2 is finished if the adhesive 4 solidifies.

In addition, the present invention is not limited to the embodiment: it goes without saying that various modifications and changes are available within the spirit and scope of the invention and that the invention covers these modified and changed inventions.

<<Modification Example>>

For example, in the embodiment, although joining the metal plates 1, 2 is described with citing as an example the square tubular joined structural body 3 with collar as shown in FIGS. 1A and 1B, the joined structural body 3 is not limited thereto and may have the flanges 12, 22 for forming the joining faces 11, 21 at a peripheral edge. For example, the joined structural body 3 is available even if it is such a tubular body having a circular space inside and a body having a box-type closed space.

In addition, in the embodiment, although a case of joining the metal plates 1, 2 and two members is cited as an example, the present invention is not limited thereto. In a metal plate joining method and structure with respect to the present invention, for example, three metal plates may be joined using electric resistance welding in combination with an adhesive, further making such a metal plate like a flat plate intervene between the metal plates 1, 2.

What is claimed is:

1. A metal plate joining method for using electric resistance welding in combination with an adhesive and joining at least two or more metal plates, the method comprising the steps of:
continuously coating the adhesive on at least one flange out of flanges respectively formed in the plurality of the metal plates;
superimposing the one flange on the other flange;
making a protrusion formed in any one flange out of the two flanges abut with the other flange; and
forming a gap between the two flanges at a flange inner edge side of the protrusion,
wherein while suppressing a move of the adhesive to a flange outer edge by the protrusion, the two flanges push the gap and are welded by the electric resistance welding.

2. A metal plate joining structure for using electric resistance welding in combination with an adhesive and joining at least two or more metal plates, the structure comprising:
a protrusion configured to suppress a move of the adhesive to an outer edge of one flange and formed in at least the one flange out of flanges respectively formed in the plurality of the metal plates,
wherein the adhesive is configured to intervene with a periphery of the protrusion between the flange of the two metal plates, and electric resistance welding is performed for a flange inner edge side of the protrusion of the flange.

3. The metal plate joining structure according to claim 2 comprising a plurality of protrusions configured to be disposed so as to surround through a predetermined interval a periphery of a welded portion welded by electric resistance welding, wherein at least one of the plurality of the protrusions is disposed at the flange outer edge side of the welded portion.
